(19) United States
(12) Patent Application Publication
(10) Pub. No.: US 2006/0152447 A1
(43) Pub. Date: Jul. 13, 2006

(54) PLASMA DISPLAY APPARATUS AND DRIVING METHOD THEREOF

(75) Inventor: Byung Joon Rhee, Yongin-si (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,498

(22) Filed: Jan. 10, 2006

(30) Foreign Application Priority Data
Jan. 10, 2005 (KR) 10-2005-0002353

(51) Int. Cl. G09G 3/28

(52) U.S. Cl. 345/67

(57) ABSTRACT

This document relates to a plasma display apparatus and driving method thereof, and more particularly, to a plasma display apparatus for driving electrodes and driving method thereof. A plasma display apparatus according to an embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs). This document is advantageous in that it can enhance driving efficiency and improve a bright afterimage, by improving a sustain pulse of a sustain period.

This Nonprovisional application claims priority under 35 U.S.C. §119(a) on Patent Application No. 10-2005-0002353 filed in Korea on Jan. 10, 2005 the entire contents of which are hereby incorporated by reference.

### BACKGROUND OF THE INVENTION

1. Field of the Invention

This document relates to a plasma display apparatus and driving method thereof, and more particularly, to a plasma display apparatus that drives electrodes and driving method thereof.

2. Background of the Related Art

In general, a plasma display apparatus among display apparatuses comprises a plasma display panel and a driver for driving the plasma display panel.

The plasma display panel comprises a front substrate and a rear substrate. A barrier rib formed between the front substrate and the rear substrate forms one unit cell. Each cell is filled with an inert gas containing a primary discharge gas, such as neon (Ne), helium (He) or a mixed gas of Ne+He, and a small amount of xenon (Xe). If the inert gas is discharged with a high frequency voltage, vacuum ultraviolet rays are generated. Phosphors formed between the barrier ribs are excited to implement images. The plasma display panel can be made thin and light, and has thus been in the spotlight as the next-generation display devices.

FIG. 1 is a perspective view illustrating the construction of a general plasma display panel.

As shown in FIG. 1, the plasma display panel comprises a front substrate 100 and a rear substrate 110. In the front substrate 100, a plurality of sustain electrode pairs in which scan electrodes 102 and sustain electrodes 103 are formed in pairs is arranged on a front glass 101 serving as a display surface on which images are displayed. In the rear substrate 110, a plurality of address electrodes 113 crossing the plurality of sustain electrode pairs is arranged on a rear glass 111 serving as a rear surface. The front substrate 100 and the rear substrate 110 are coupled to each other in parallel with a predetermined distance therebetween.

The front substrate 100 comprises the pairs of scan electrodes 102 and sustain electrodes 103, which mutually discharge one another and maintain the emission of a cell within one discharge cell. In other words, each of the scan electrode 102 and the sustain electrode 103 has a transparent electrode “a” formed of a transparent ITO material and a bus electrode “b” formed of a metal material. The scan electrodes 102 and the sustain electrodes 103 are covered with one or more dielectric layers 104 for limiting a discharge current and providing insulation among the electrode pairs. A protection layer 105 having Magnesium Oxide (MgO) deposited thereon is formed on the dielectric layers 104 so as to facilitate discharge conditions.

In the rear substrate 110, barrier ribs 112 of stripe form (or well form), for forming a plurality of discharge spaces, i.e., discharge cells are arranged parallel to one another. Furthermore, a plurality of address electrodes 113, which performs an address discharge to generate vacuum ultraviolet rays, are in parallel disposed between the barrier ribs 112. R, G and B phosphor layers 114 that radiate a visible ray for displaying images during an address discharge are coated on a top surface of the rear substrate 110. A dielectric layer 115 for protecting the address electrodes 113 is formed between the address electrodes 113 and the phosphor layers 114.

A method of implementing gray levels of an image in the plasma display panel as constructed above will be described below with reference to FIG. 2.

FIG. 2 is a view illustrating a method of implementing gray levels of an image of a plasma display apparatus in the related art.

As shown in FIG. 2, in order to represent image gray levels of the plasma display panel in the related art, one frame is divided into several sub-fields having a different number of emissions. Each of the sub-fields is divided into a reset period (RPD) for initializing the entire cells, an address period (APD) for selecting a cell to be discharged, and a sustain period (SPD) for implementing gray levels depending on the number of discharges. For example, if it is desired to display images with 256 gray levels, a frame period (16.67 ms) corresponding to 1/60 seconds is divided into eight sub-fields (SF1 to SF8) as shown in FIG. 2. Each of the eight sub-fields (SF1 to SF8) is again divided into a reset period, an address period and a sustain period.

The reset period and the address period of each sub-field are the same every sub-field. An address discharge for selecting a cell to be discharged is generated due to a voltage difference between the address electrodes and the scan electrodes (i.e., transparent electrodes). The sustain period increases in the ratio of 2ⁿ (where n=0,1,2,3,4,5,6,7) in each sub-field. Since the sustain period is varied every sub-field as described above, gray levels of an image are represented by controlling the sustain period of each sub-field, i.e., a sustain discharge number. A driving waveform depending on the method of driving the plasma display panel will be described below with reference to FIG. 3.

FIG. 3 shows a driving waveform depending on the method of driving the plasma display apparatus in the related art.

As shown in FIG. 3, the plasma display panel is driven with each sub-field of one frame being divided into a reset period for initializing the entire cells, an address period for selecting cells to be discharged, a sustain period for sustaining the discharge of selected cells and an erase period for erasing wall charges within discharged cells.

In a set-up period of the reset period, a ramp-up waveform (Ramp-up) is applied to the entire scan electrodes at the same time. The ramp-up waveform generates a weak dark discharge within the discharge cells of the entire screen. The set-up discharge also causes positive wall charges to be accumulated on the address electrodes and the sustain electrodes, and negative wall charges to be accumulated on the scan electrodes.

In a set-down period of the reset period, after the ramp-up waveform has been applied, a ramp-down waveform (Ramp-down), which begins falling from a positive voltage lower than a peak voltage of the ramp-up waveform to a predetermined voltage level lower than a ground (GND) level voltage, generates a weak erase discharge within the cells, thus sufficiently erasing wall charges excessively formed on the scan electrodes. The set-down discharge causes wall charges of the degree in which an address discharge can be stably generated to uniformly remain within the cells.

In the address period, while a negative scan pulse (Scan) is sequentially applied to the scan electrodes, a positive data pulse is applied to the address electrodes in synchronization with the scan waveform. As a voltage difference between the scan pulse and the data pulse and a wall voltage generated in the reset period are added, an address discharge is generated within the discharge cells to which the data pulse is applied. Furthermore, wall charges of the degree in which a discharge can be generated when a sustain voltage (Vs) is applied are formed within cells selected by the address discharge. During the set-down period and the address period, the sustain electrode is supplied with a positive voltage (Vz) for preventing an erroneous discharge from being generated between the sustain electrode and the scan electrodes by reducing a voltage difference between the sustain electrode and the scan electrodes.

In the sustain period, a sustain pulse (sus) is alternately applied to the scan electrode and the sustain electrode. As a wall voltage within the cells and the sustain pulse are added, a sustain discharge, i.e., a display discharge is generated between the scan electrode and the sustain electrode in the cells selected by the address discharge whenever the sustain pulse is applied.

After the sustain discharge has been completed, in the erase period, a voltage of an erase ramp waveform (Ramp-ers) having a narrow pulse width and a low voltage level is applied to the sustain electrodes, thereby erasing wall charges remaining within the cells of the entire screen.

In the related art plasma display panel driven as described above, if a discharge is locally generated on the display surface of the panel, a problem arises because an afterimage, e.g., a bright afterimage is usually generated.

FIG. 4 is a view illustrating afterimages generated in the related art plasma display apparatus.

As shown in FIG. 4, in the case where a predetermined window pattern is displayed at a central portion of the screen, the window pattern concentrically generates a discharge at a portion 400a of a panel display surface 400. If the discharge is generated over the entire panel 400b, the window pattern that had been displayed at the portion 400a of the panel display surface 400 appears as an afterimage 400c. This afterimage 400c can be generated because of several causes, but is eventually generated due to instable emission efficiency of phosphors when a cell of the panel display surface is discharged.

More particularly, recently, the xenon (Xe) content within the discharge cell increases so as to improve characteristics of discharge efficiency. Such increase in the xenon (Xe) content within the discharge cell further generates a bright afterimage phenomenon as described above. The correlation between the xenon (Xe) content within the discharge cell and a discharge type within the discharge cell will be described below with reference to FIG. 5.

FIG. 5 is a view illustrating a discharge phenomenon appearing as an amount of xeon (Xe) injected into the related art plasma display apparatus increases.

As shown in FIG. 5, a discharge within a discharge cell in which the xenon (Xe) content is high is attracted toward an address electrode 113. This discharge will be described below in connection with FIG. 6 showing, in more detail, a sustain pulse of the sustain period in the related art driving waveform shown in FIG. 3.

For example, if the sustain voltage (Vs) is applied to the scan electrode 102 with a voltage of a ground level being applied to the address electrode 113 and the sustain electrode 103, a sustain discharge by the scan electrode 102 is generated. Unlike the above example, if the sustain voltage (Vs) is applied to the sustain electrode 103 with a voltage of a ground level being applied to the address electrode 113 and the scan electrode 102, a sustain discharge by the sustain electrode 103 is generated. Such a sustain discharge is dependent upon a surface discharge generated between the scan electrode 102 and the sustain electrode 103. If an amount of xenon (Xe) within the plasma display panel increases, however, an electric field between the scan electrode 102 and the sustain electrode 103 is distributed through strong interaction with the address electrode 113 during the surface discharge between the scan electrode 102 and the sustain electrode 103. As a result, a discharge within the discharge cell is further attracted toward the address electrode 113. That is, the higher the xenon (Xe) content within the discharge cell, the more the discharge within the discharge cell is attracted toward the address electrode 113.

Furthermore, in the sustain pulse of FIG. 6, a period where the sustain voltage (Vs) is supplied to the scan electrode 102 and is then sustained, and a period where the sustain voltage (Vs) is supplied to the sustain electrode 103 and is then sustained are the same. In this case, while the sustain voltage (Vs) is supplied to the scan electrode 102, a strong discharge is generated. Even while the sustain voltage (Vs) is supplied to the sustain electrode 103, a strong discharge is generated. Therefore, a discharge within the discharge cell is further attracted toward the address electrode 113.

The more a discharge within the discharge cell is further attracted toward the address electrode 113 as described above, the more the lower phosphor of the phosphors of the plasma display panel is degraded. As a result, the lifespan of the plasma display panel is shortened and a bright afterimage is further generated. In this case, the above-described phosphor is in a very unstable state when a plasma display panel is first manufactured. To stabilize the unstable state of the phosphor, aging is performed when fabricating the plasma display panel. The aging process on the phosphor will be described below with reference to FIG. 7.

FIG. 7 is a view illustrating aging performed in order to stabilize phosphors of a plasma display apparatus.

As shown in FIG. 7, upon aging carried out in order to stabilize phosphors of the plasma display panel, sidewall phosphor 114a formed closer to a barrier rib 112 than lower phosphor 114b, of phosphors 114 of the plasma display panel, is relatively further degraded. Therefore, the sidewall phosphor 114a is more stabilized than the lower phosphor 114b.

As a result, upon aging of the plasma display panel, an absolute luminance of the sidewall phosphor 114a is significantly lowered than the lower phosphor 114b. Therefore, a discharge shaking width of the sidewall phosphor 114a becomes smaller than that of the lower phosphor 114b. Such discharge shaking will be described below with reference to FIG. 8.

FIG. 8 is a view illustrating discharge shaking in phosphors of a plasma display apparatus.

As shown in FIG. 8, lower phosphor of phosphors of a plasma display panel has a discharge shaking width, which is relatively larger than that of sidewall phosphors. That is, a time taken to return to a stable state after the lower phosphor has been discharged is relatively longer than that of the sidewall phosphors.

Therefore, as described above, an amount of xenon (Xe) increases or only a strong discharge is repeatedly generated between the scan electrode and the sustain electrode in the sustain period. For this reason, if a surface discharge that is generated between the scan electrode and the sustain electrode within the discharge cell is attracted toward the address electrode, the lower phosphor that has been relatively less degraded upon aging of the plasma display panel is degraded. This results in a reduced lifespan of the plasma display panel. Furthermore, the lower phosphor having a return time taken to return to a stable state after a discharge is relatively long emits light. Therefore, a bright afterimage is generated on the display surface of the plasma display panel.

The problem of such a bright afterimage can be solved by lengthening a rising (ER-Up) time of the first sustain pulse applied to the scan electrode and the sustain electrode during the surface discharge. The term “ER_Up time” (Energy Recovery Time) refers to a time taken until the sustain pulse rises from 0V to the sustain voltage (Vs). If the rising (ER-Up) time is lengthened, the attraction of a discharge toward the address electrode during the surface discharge can be reduced. This may lead to a reduced bright afterimage.

If the ER_Up time of the sustain pulse is set to be long, an afterimage appearing on the screen can be improved. However, problems arise in that a load effect and an erroneous discharge occurrence ratio at high temperature abruptly rise and margin is also reduced.

### SUMMARY OF THE INVENTION

Accordingly, an object of an embodiment of the present invention is to solve at least the problems and disadvantages of the background art.

It is an object of an embodiment of the present invention to reduce generation of a bright afterimage by improving the sustain pulse of the sustain period.

It is another object of an embodiment of the present invention to enhance driving efficiency by improving the sustain pulse of the sustain period.

To achieve the above objects, a plasma display apparatus according to an embodiment of the present invention a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

A plasma display apparatus according to another embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs), and a rising (ER-Up) period of the second sustain pulse applied to the sustain electrode and a Z sustain period where the second sustain pulse is maintained at the sustain voltage (Vs) are varied depending on a cell pitch of a discharge cell.

According to further another embodiment of the present invention, there is provided a method of driving a plasma display panel comprising a scan electrode and a sustain electrode, the method comprising the steps of: overlapping a first sustain pulse applied to the scan electrode and a second sustain pulse applied to the sustain electrode with each other; and setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

The present invention can improve the sustain pulse of the sustain period. Therefore, there are advantages in that driving efficiency can be enhanced and a bright afterimage can be improved.

### BRIEF DESCRIPTION OF THE DRAWINGS

The embodiment of the invention will be described in detail with reference to the following drawings in which like numerals refer to like elements.

FIG. 1 is a perspective view illustrating the structure of a general plasma display panel;

FIG. 2 is a view illustrating a method of implementing gray levels of an image of a plasma display apparatus in the related art;

FIG. 3 shows a driving waveform depending on the method of driving the plasma display apparatus in the related art;

FIG. 4 is a view illustrating afterimages generated in the related art plasma display apparatus;

FIG. 5 is a view illustrating a discharge phenomenon appearing as an amount of xenon injected into the related art plasma display apparatus increases;

FIG. 6 shows a sustain waveform in a sustain period in a driving waveform depending on a method of driving a plasma display apparatus in the related art;

FIG. 7 is a view illustrating aging performed in order to stabilize phosphors of a plasma display apparatus;

FIG. 8 is a view illustrating discharge shaking in phosphors of a plasma display apparatus;

FIG. 9 is a view illustrating the construction of a plasma display apparatus according to an embodiment of the present invention;

FIG. 10 is a view illustrating an example of a driving waveform according to a method of driving a plasma display apparatus according to an embodiment of the present invention;

FIG. 11 shows a sustain pulse of a sustain period, of the driving waveform according to the method of driving the plasma display apparatus according to an embodiment of the present invention;

FIG. 12 is a view illustrating, in more detail, a driving waveform according to the method of driving the plasma display apparatus according to an embodiment of the present invention;

FIG. 13 is a view illustrating, in more detail, a portion where sustain pulses of a scan electrode and a sustain electrode are overlapped with each other;

FIG. 14 shows another driving waveform depending on the method of driving the plasma display apparatus according to an embodiment of the present invention;

FIG. 15 is a view illustrating, in more detail, a driving waveform according to the method of driving the plasma display apparatus according to an embodiment of the present invention; and

FIG. 16 is a view illustrating, in more detail, a portion where sustain pulses of a scan electrode and a sustain electrode are overlapped with each other.

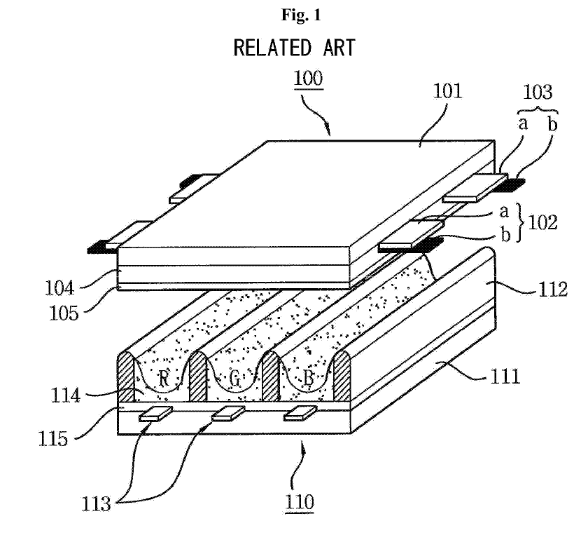

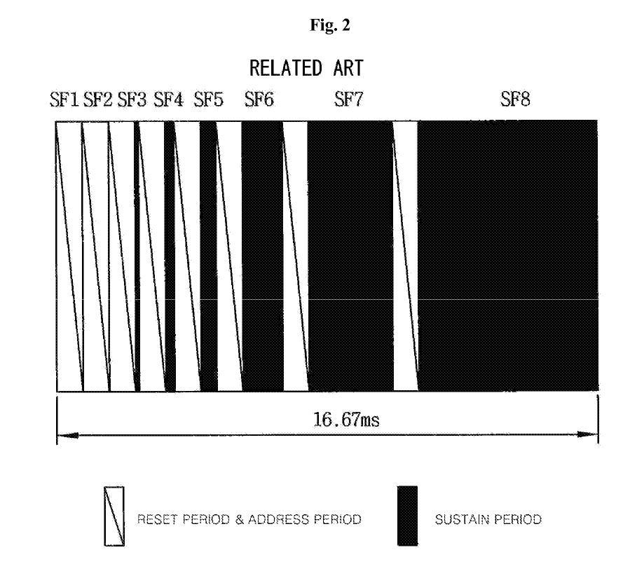

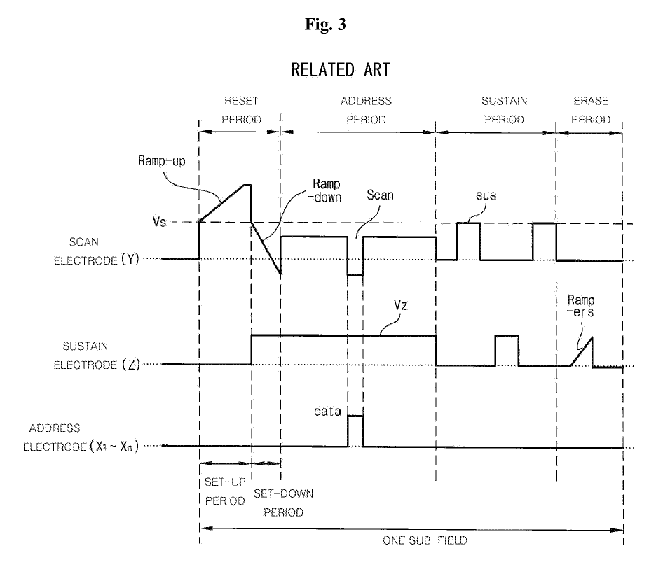

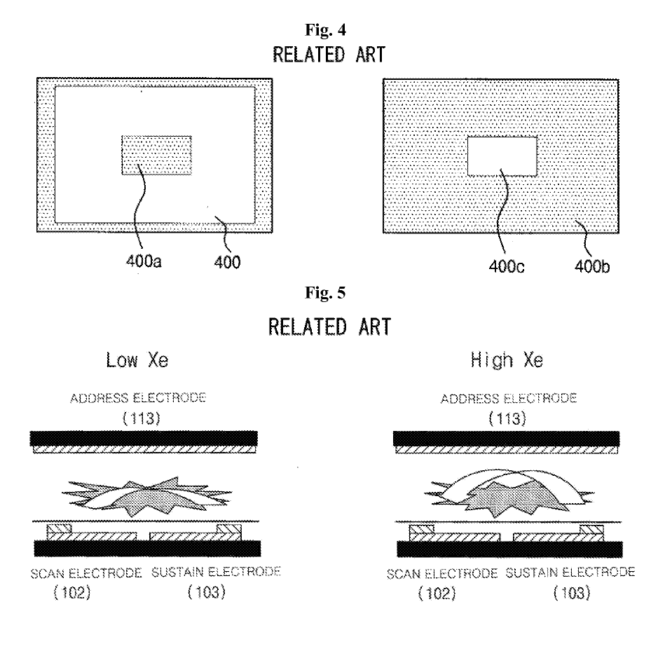

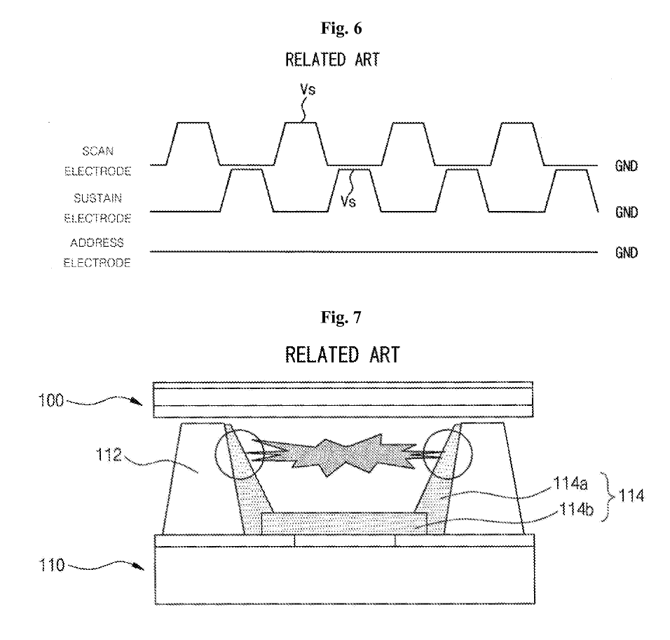

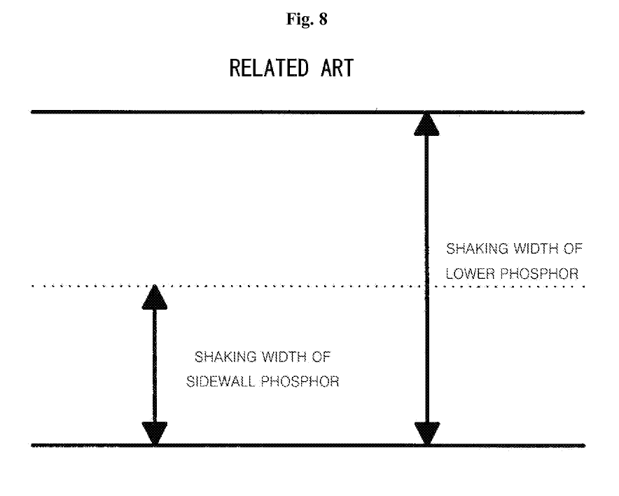

### DETAILED DESCRIPTION OF THE PREFERRED EMBODIMENT

Embodiments of the present invention will be described in a more detailed manner with reference to the drawings.

A plasma display apparatus according to an embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

A point where the first sustain pulse and the second sustain pulse are overlapped with each other is a point within a range of ±50 ns from a point of ½ (Vs/2) of the sustain voltage (Vs).

At the overlapped point, a falling (ER-Down) period of the sustain pulse and a rising (ER-Up) period of the sustain pulse are different from each other.

At the overlapped point, the falling (ER-Down) period of the sustain pulse is less than or equal to the rising (ER-Up) period of the sustain pulse.

At the overlapped point, the falling (ER-Down) period and the rising (ER-Up) period of the sustain pulse is 400 ns or more.

The overlapped point is a point where the first sustain pulse applied to the scan electrode falls (ER-Down) and the second sustain pulse applied to the sustain electrode rises (ER-Up).

A plasma display apparatus according to another embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs), and a rising (ER-Up) period of the second sustain pulse applied to the sustain electrode and a Z sustain period where the second sustain pulse is maintained at the sustain voltage (Vs) are varied depending on a cell pitch of a discharge cell.

As the cell pitch of the discharge cell decreases, a difference between the rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) increases.

The cell pitch of the discharge cell is a Full High Definition (Full HD) grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

The cell pitch of the discharge cell is an Extended Graphics Array (XGA) grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

According to further another embodiment of the present invention, there is provided a method of driving a plasma display panel comprising a scan electrode and a sustain electrode, the method comprising the steps of: overlapping a first sustain pulse applied to the scan electrode and a second sustain pulse applied to the sustain electrode with each other; and setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

A point where the first sustain pulse applied to the scan electrode and the second sustain pulse applied to the sustain electrode are overlapped with each other is a point within a range of ±50 ns from a point of ½ (Vs/2) of the sustain voltage (Vs).

At the overlapped point, a falling (ER-Down) period of the sustain pulse and a rising (ER-Up) period of the sustain pulse are different from each other.

At the overlapped point, the falling (ER-Down) period of the sustain pulse is less than or equal to the rising (ER-Up) period of the sustain pulse.

At the overlapped point, the falling (ER-Down) period and the rising (ER-Up) period of the sustain pulse is 400 ns or more.

The overlapped point is a point where the first sustain pulse applied to the scan electrode falls (ER-Down) and the second sustain pulse applied to the sustain electrode rises (ER-Up).

The rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) are varied depending on a cell pitch of a discharge cell.

As the cell pitch of the discharge cell decreases, a difference between the rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) increases.

The cell pitch of the discharge cell is a Full HD grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

The cell pitch of the discharge cell is an XGA grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

Detailed embodiments of the present invention will now be described in connection with reference to the accompanying drawings.

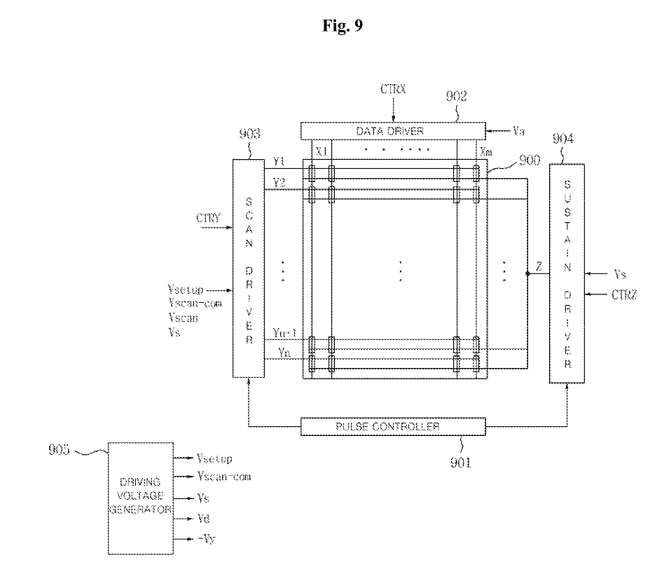

FIG. 9 is a view illustrating the construction of a plasma display apparatus according to an embodiment of the present invention.

As shown in FIG. 9, the plasma display apparatus according to an embodiment of the present invention comprises a plasma display panel 900 in which driving pulses are applied to address electrodes X1 to Xm, scan electrodes Y1 to Yn and a sustain electrode Z in a reset period, an address period and a sustain period, a data driver 902, a scan driver 903, a sustain driver 904, a pulse controller 901 and a driving voltage generator 905. The data driver 902 supplies data to the address electrodes X1 to Xm formed in the plasma display panel 900. The scan driver 903 drives the scan electrodes Y1 to Yn. The sustain driver 904 drives the sustain electrode Z, i.e., a common electrode. The pulse controller 801 controls the scan driver 903 and the sustain driver 904 when the plasma display panel 900 is driven and controls the supply of a reset pulse in the reset period. The pulse controller 801 controls the supply of a scan pulse in the address period and also controls a voltage or width of a sustain pulse in the sustain period. The driving voltage generator 905 supplies driving voltages necessary for the respective driver 902, 903 and 904.

The data driver 902 is supplied with data, which have underwent inverse gamma correction, error diffusion, etc. by means of an inverse gamma correction circuit, an error diffusion circuit, etc., and then mapped to respective sub-fields by means of a sub-field mapping circuit. The data driver 902 samples and latches the data in response to a data timing control signal (CTRX) output from a timing controller (not shown) and provides the data to the address electrodes X1 to Xm. The data driver 902 also supplies the address electrodes X1 to Xm with an erase pulse during an erase period.

The scan driver 903 supplies the reset pulse to the scan electrodes Y1 to Yn during the reset period and the scan pulse to the scan electrodes Y1 to Yn during the address period, under the control of the pulse controller 901. It also provides the sustain pulse to the scan electrodes Y1 to Yn during the sustain period and the erase pulse to the scan electrodes Y1 to Yn during the erase period, under the control of the pulse controller 901.

The sustain driver 904 supplies a predetermined bias voltage to the sustain electrodes Z during the address period under the control of the pulse controller 901, and also alternately operates with the scan driver 903 during the sustain period, thus providing a sustain pulse (Vs) to the sustain electrodes Z. Furthermore, the sustain driver 904 provides the erase pulse to the sustain electrodes Z during the erase period.

The pulse controller 901 supplies the respective driver 902, 903 and 904 with predetermined control signals for controlling an operating timing and synchronization of the data driver 902, the scan driver 903 and the sustain driver 904 in the reset period, the address period, the sustain period and the erase period.

More particularly, unlike the related art, the pulse controller 901 according to an embodiment of the present invention can control the scan driver 903 and the sustain driver 904, so that the Z sustain period where the first sustain pulse applied to the scan electrodes and the second sustain pulse applied to the sustain electrodes are overlapped with each other, and the ER-Up period of the Z sustain period where the first sustain pulse applied to the scan electrodes and a Y sustain period where the sustain voltage (Vs) is sustained are different from the ER-Up period of the second sustain pulse applied to the sustain electrode and the Z sustain period where the sustain voltage (Vs) is sustained.

Furthermore, the pulse controller 901 according to another embodiment of the present invention can control the scan driver 903 and the sustain driver 904, so that the ER-Up period of the Z sustain period where the first sustain pulse applied to the scan electrodes and the Y sustain period where the sustain voltage (Vs) is sustained and the ER-Up period of the second sustain pulse applied to the sustain electrodes and a Z sustain period where the sustain voltage (Vs) is sustained are varied depending on a cell pitch of a discharge cell. This will be described in detail later on.

Meanwhile, the data control signal (CTRX) contains a sampling clock for sampling data, a latch control signal, and a switching control signal for controlling an on/off time of an energy recovery circuit (not shown) and a driving switch element (not shown). The scan control signal (CTRY) contains a switching control signal for controlling an on/off time of an energy recovery circuit (not shown) and a driving switch element (not shown) within the scan driver 903. The sustain control signal (CTRZ) contains a switching control signal for controlling an on/off time of an energy recovery circuit (not shown) and a driving switch element (not shown) within the sustain driver 904.

The driving voltage generator 905 generates a set-up voltage (Vsetup), a common scan voltage (Vscan-com), a scan voltage (−Vy), a sustain voltage (Vs), a data voltage (Vd) and the like. These driving voltages may be varied depending upon the composition of a discharge gas or the structure of a discharge cell.

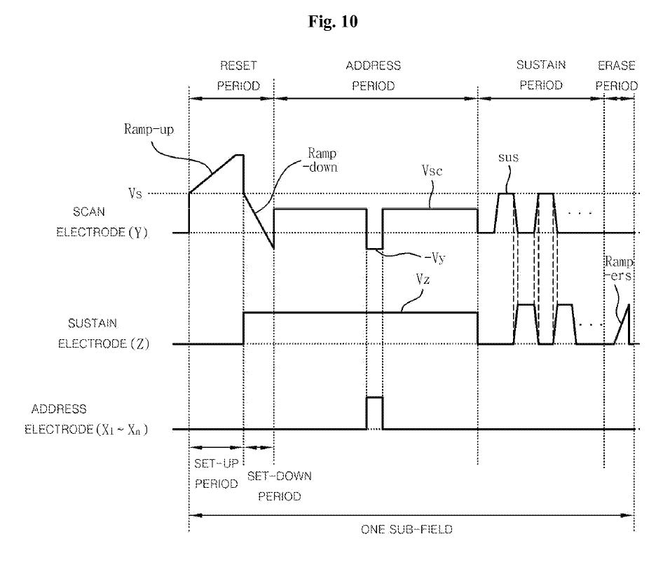

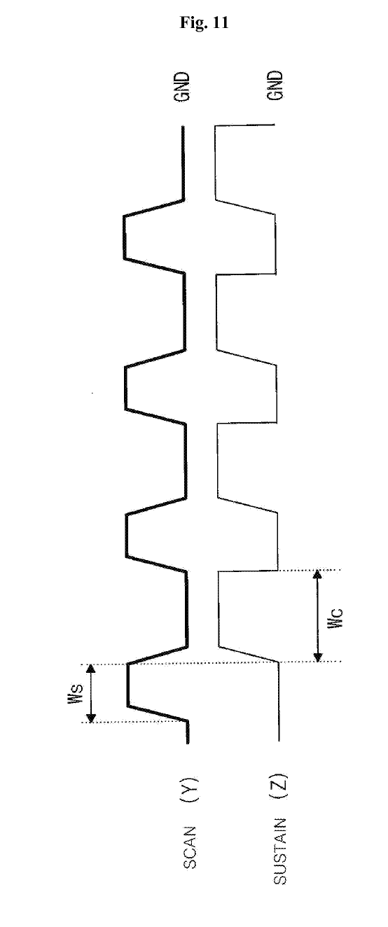

FIG. 10 is a view illustrating an example of a driving waveform according to a method of driving a plasma display apparatus according to an embodiment of the present invention.

As shown in FIG. 10, in the method of driving the plasma display apparatus according to an embodiment of the present invention, the plasma display apparatus is driven with it one frame being divided into a reset period for initializing the entire cells, an address period for selecting a cell to be discharged, a sustain period for sustaining the discharge of a selected cell and an erase period for erasing wall charges within a discharged cell.

In a set-up period of the reset period, a ramp-up waveform (Ramp-up) is applied to the entire scan electrodes at the same time. The ramp-up waveform generates a discharge within the discharge cells of the entire screen. The ramp-up discharge also causes positive wall charges to be accumulated on the address electrodes and the sustain electrodes, and negative wall charges to be accumulated on the scan electrodes.

In a set-down period of the reset period, after the ramp-up waveform is applied, a ramp-down waveform (Ramp-down), which falls from a positive voltage lower than a peak voltage of the ramp-up waveform to a predetermined voltage level lower than a ground (GND) level voltage, generates a weak erase discharge within the cells, thereby sufficiently erasing wall charges that have been excessively formed on the scan electrodes. The set-down discharge causes wall charges of the degree in which an address discharge can be stably generated to uniformly remain within the cells.

In the address period, while a negative scan pulse is sequentially applied to the scan electrodes, a positive data pulse is applied to the address electrodes in synchronization with the scan pulse. As a voltage difference between the scan pulse and the data pulse and a wall voltage generated in the reset period are added, an address discharge is generated within the discharge cell to which the data pulse is applied. Furthermore, wall charges of the degree in which a discharge can be generated when the sustain voltage is applied are formed within a cell selected by the address discharge. During the set-down period and the address period, the sustain electrodes Z are supplied with a positive voltage (Vz) such that an erroneous discharge is not generated between the sustain electrodes and the scan electrodes by reducing a voltage difference between the sustain electrodes and the scan electrodes.

In the sustain period, a sustain pulse (sus) is alternately applied to the scan electrodes and the sustain electrodes. As a wall voltage within the cells and the sustain pulse are added, a sustain discharge, i.e., a display discharge is generated between the scan electrodes and the sustain electrodes in cells selected by an address discharge whenever the sustain pulse is applied.

After the sustain discharge had been completed, in the erase period, a voltage of an erase ramp pulse (Ramp-ers) having a narrow pulse width and a low voltage level is applied to the sustain electrodes, thereby erasing wall charges remaining within the cells of the entire screen.

More particularly, unlike the related art, the method of driving the plasma display apparatus according to an embodiment of the present invention is characterized in the sustain period. The sustain pulse applied in the sustain period will be described below in more detail with reference to FIG. 11.

FIG. 11 shows the sustain pulse of the sustain period, of the driving waveform according to the method of driving the plasma display apparatus according to an embodiment of the present invention.

As shown in FIG. 11, in the driving waveform according to the method of driving the plasma display apparatus according to an embodiment of the present invention, the first sustain pulse applied to the scan electrode Y and the second sustain pulse applied to the sustain electrode Z in the sustain period are overlapped with each other. At this time, the sum of a period (Ws) where the slope of the first sustain pulse applied to the scan electrode Y is 0 or higher (0≧), i.e., the ER-Up period of the first sustain pulse applied to the scan electrode Y, and the Y sustain period where the sustain voltage (Vs) is sustained is different from the sum of a period (Wc) where the slope of the second sustain pulse applied to the sustain electrode Z is 0 or higher (0≧), i.e., the ER-Up period of the sustain pulse applied to the sustain electrode, and the Z sustain period where the sustain voltage (Vs) is sustained.

It has been shown in FIG. 9 that the sustain pulses are overlapped with each other in a period where the first sustain pulse applied to the scan electrode Y falls (ER-Down) and the second sustain pulse applied to the sustain electrode Z rises (ER-Up). However, according to the present invention, the sustain pulses can be overlapped with each other in a period where the first sustain pulse applied to the scan electrode Y rises (ER-Up) and the second sustain pulse applied to the sustain electrode Z falls (ER-Down), or the sustain pulses can be overlapped with each other in a period where the first sustain pulse applied to the scan electrode Y rises (ER-Up) or fall (ER-Down) and the second sustain pulse applied to the sustain electrode Z corresponding to it falls (ER-Down) or rises (ER-Up).

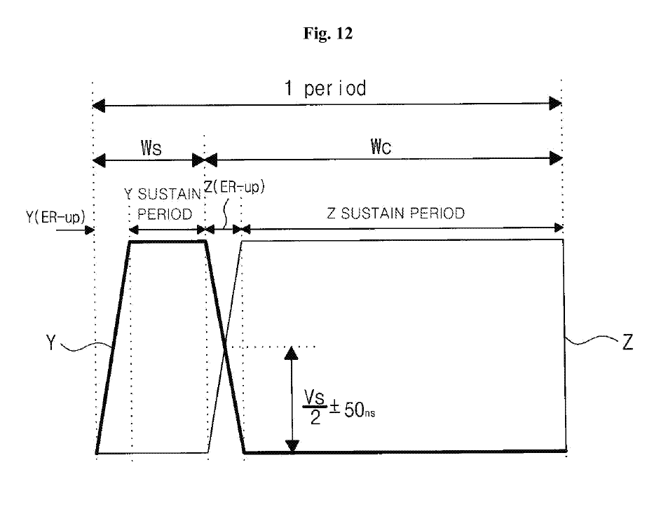

In this case, in the driving waveform according to an embodiment of the present invention, the period (Ws) where the slope of the first sustain pulse applied to the scan electrode Y is 0 or higher (0≧), i.e., the Y sustain period where the sustain voltage (Vs) is sustained from a Y (rising (ER-Up)) period of the first sustain pulse applied to the scan electrode Y, and the period (Wc) where the slope of the second sustain pulse applied to the sustain electrode Z is 0 or higher (0≧), i.e., the Z sustain period where the sustain voltage (Vs) is sustained from a Z (rising (ER-Up)) period of the second sustain pulse applied to the sustain electrode Z are different from each other. However, in FIG. 9, only a case where the period (Ws) where the slope of the first sustain pulse applied to the scan electrode Y is 0 or higher (0≧) is shorter than the period (Wc) where the slope of the second sustain pulse applied to the sustain electrode Z is 0 or higher (0≧) has been shown. A case opposite to the above-mentioned case will be described with reference to FIG. 12.

In this case, the first sustain pulse applied to the scan electrode Y gradually rises or falls at a predetermined slope upon rise or fall. Furthermore, the second sustain pulse applied to the sustain electrode Z also gradually rises or falls at a predetermined slope upon rise or fall. That is, as shown in FIG. 9, the sustain pulse has a rising (ER-Up) time or a falling (ER-Down) time having a predetermined length.

This is to minimize an interaction with the address electrode by reducing an instant potential during the sustain discharge Therefore, a phenomenon in which a discharge is attracted toward the address electrode during the sustain discharge decreases. It is thus possible to stably sustain discharge efficiency of each phosphor and also to reduce generation of an afterimage, i.e., a bright afterimage.

Furthermore, as the first sustain pulse applied to the scan electrode Y is overlapped with the second sustain pulse applied to the sustain electrode Z as described above, a reduction in sustain margin, which is generated as the ER-Down period or the ER-Up period of the first sustain pulse applied to the scan electrode Y or the sustain electrode Z is lengthened, can be prevented.

For example, if the first sustain pulse applied to the scan electrode Y or the second sustain pulse applied to the sustain electrode Z gradually rises or falls at a predetermined slope upon rising or falling as described above, generation of a bright afterimage can be prohibited, but sustain margin becomes worse since a time where one sustain pulse is applied is lengthened. Therefore, as the first sustain pulse applied to the scan electrode Y and the second sustain pulse applied to the sustain electrode Z are overlapped as described above, sustain margin can be prevented from becoming worse.

Furthermore, the reason why the first sustain pulse applied to the scan electrode Y and the second sustain pulse applied to the sustain electrode Z are overlapped with each other is to apply a sustain pulse of a low voltage to the sustain electrode Z by using priming particles of a self discharge, which are generated when the first sustain pulse applied to the scan electrode Y falls (ER-Down).

Furthermore, the period where the sustain voltage (Vs) of the first sustain pulse applied to the scan electrode Y is sustained, i.e., the Y sustain period, and the period where the sustain voltage (Vs) of the second sustain pulse applied to the sustain electrode Z is sustained, i.e., the Z sustain period, as described above, are different from each other. The sustain pulses in this case will now be described in more detail with reference to FIG. 12.

FIG. 12 is a view illustrating, in more detail, a driving waveform according to the method of driving the plasma display apparatus according to an embodiment of the present invention.

As shown in FIG. 12, a point where the first sustain pulse applied to the scan electrode Y and the second sustain pulse applied to the sustain electrode Z, in the sustain period, are overlapped with each other can be a point within a range of ±50 ns from the time point of ½ (Vs/2) of the sustain voltage (Vs).

For example, assuming that a time point where the first sustain pulse applied to the scan electrode Y or the sustain electrode Z becomes ½ (Vs/2) of the sustain voltage (Vs) is 200 ns, a point where the first sustain pulse applied to the scan electrode Y and the second sustain pulse applied to the sustain electrode Z in the above-described sustain period are overlapped with each other is a point ranging from a time point, which is 50 ns prior to the time point of ½ (Vs/2) of the sustain voltage (Vs), i.e., a time point of 150 ns to a time point, which is 50 ns subsequent to the time point of ½ (Vs/2) of the sustain voltage (Vs), i.e., a time point of 250 ns.

Therefore, a sustain discharge can be further stabilized. Furthermore, the rise of a discharge voltage, which is generated as the rising (ER-Up) time of the sustain pulse is lengthened, in the scan electrode Y is not generated because a sustain discharge is generated even if even a low voltage is applied to the sustain electrode. The rise of the discharge voltage does not occur although the sustain pulses are overlapped with each other while the rising (ER-Up) time of the scan electrode Y and the sustain electrode Z is changed.

In the driving waveform according to an embodiment of the present invention, the period (Ws) where the slope of the first sustain pulse applied to the scan electrode Y is 0 or higher (0≧) is different from the period (Wc) where the slope of the second sustain pulse applied to the sustain electrode Z is 0 or higher (0≧), as described above.

That is, a period where the sustain voltage (Vs) is sustained from the start when the first sustain pulse applied to the scan electrode Y rises and a period where the sustain voltage (Vs) is sustained from the start when the second sustain pulse applied to the sustain electrode Z rises are different from each other. Therefore, during one period of the sustain pulse, a weak discharge and a strong discharge are alternately generated.

In other words, assuming that a period where the slope of the first sustain pulse applied to the scan electrode Y is 0 or higher (0≧), i.e., a Y sustain period where the sustain voltage (Vs) is sustained from the start when the first sustain pulse applied to the scan electrode Y rises (ER-Up) is relatively longer than a period where the slope of the second sustain pulse applied to the sustain electrode Z is 0 or higher (0≧), during one period of the sustain pulse, a discharge in this period is relatively strong. In this case, since the scan electrode Y is maintained at the sustain voltage (Vs) and the sustain electrode Z is maintained at the ground level (GND), a discharge is generated.

Therefore, a discharge in the period where the slope of the second sustain pulse applied to the sustain electrode Z is 0 or higher (0≧), i.e., the period where the second sustain pulse applied to the sustain electrode Z is maintained at the sustain voltage (Vs) from the start when rising (ER-Up) within one period of the sustain pulse becomes relatively weak. As a result, as a strong discharge and a weak discharge are alternately generated as described above, a phenomenon in which a discharge is attracted toward the address electrode upon discharge can be reduced and an afterimage can be improved accordingly.

In the case where the period (Ws) where the slope of the first sustain pulse applied to the scan electrode Y is 0 or higher (0≧) and the period (Wc) where the slope of the second sustain pulse applied to the sustain electrode Z is 0 or higher (0≧) are set to be different from each other, a difference between the lengths of the periods can be varied depending on the size of a discharge cell, i.e., a cell pitch.

In other words, the period where the slope of the first sustain pulse applied to the scan electrode Y is 0 or higher (0≧) (the sum of the ER-Up period of the first sustain pulse applied to the scan electrode and the Y sustain period where the first sustain pulse is maintained at the sustain voltage (Vs)), and the period where the slope of the second sustain pulse applied to the sustain electrode Z is 0 or higher (0≧) (the sum of the ER-Up period of the second sustain pulse applied to the sustain electrode and the Z sustain period where the second sustain pulse is maintained at the sustain voltage (Vs)) are varied depending on a cell pitch of a discharge cell.

In this case, it is preferred that a difference between the period (Ws) where the slope of the first sustain pulse applied to the scan electrode Y is 0 or higher (0≧) and the period (Wc) where the slope of the second sustain pulse applied to the sustain electrode is 0 or higher (0≧) increases as the cell pitch of the discharge cell becomes small.

The smaller the cell pitch of the discharge cell, the less the amount of wall charges within one discharge cell. Therefore, it is not a problem if a time taken to generate a sufficient amount of wall charges, which is necessary for a discharge, within the discharge cell is short. Furthermore, since the size of the discharge cell becomes small and a distance between electrodes becomes short, a sufficient discharge can be generated even with a relatively low voltage.

It has been described that as a difference between the intensities of discharges that are alternately generated when a relatively strong discharge and a relatively weak discharge are alternately generated is great, a phenomenon in which the discharge is attracted toward the address electrode upon discharge decreases. This is because it is advantageous in improving an afterimage by setting a difference between the period (Ws) where the slope of the first sustain pulse applied to the scan electrode Y is 0 or higher (0≧) and the period (Wc) where the slope of a pulse applied to the sustain electrode Z is 0 or higher (0≧) to be great as the size of the cell pitch of a discharge cell is smaller.

For example, in the case where the cell pitch of a discharge cell is VGA grade, if the period (Ws) where the slope of the first sustain pulse applied to the scan electrode Y is 0 or higher (0≧) is set to be shorter than the period (Wc) where the slope of a pulse applied to the sustain electrode Z is 0 or higher (0≧), the period (Ws) where the slope of the first sustain pulse applied to the scan electrode Y is 0 or higher has a length, which is 20% to 25% of one period of the sustain pulse. In this case, the period (Wc) where the slope of the second sustain pulse applied to the sustain electrode Z is 0 or higher can be set to be 75% to 80% of one period of the sustain pulse.

The VGA is one of the standards representing resolutions and is decided according to the cell pitch of a discharge cell. The VGA has been widely known and thus will not be described.

Furthermore, in the event that the cell pitch of a discharge cell is a XGA grade, if the period (Ws) where the slope of the first sustain pulse applied to the scan electrode Y is 0 or higher (0≧) is set to be shorter than the period (Wc) where the slope of a pulse applied to the sustain electrode Z is 0 or higher (0≧), the period (Ws) where the slope of the first sustain pulse applied to the scan electrode Y is 0 or higher is 15% to 20% of one period of the sustain pulse. In this case, the period (Wc) where the slope of the second sustain pulse applied to the sustain electrode Z is 0 or higher can be set to be 80% to 85% of one period of the sustain pulse.

The XGA is one of the standards representing resolutions and is decided according to the cell pitch of a discharge cell. The XGA has been widely known in the same manner as VGA and thus will not be described.

Furthermore, in the case where the cell pitch of a discharge cell is a Full HD grade, if the period (Ws) where the slope of the first sustain pulse applied to the scan electrode Y is 0 or higher (0≧) is set to be shorter than the period (Wc) where the slope of a pulse applied to the sustain electrode Z is 0 or higher (0≧), the period (Ws) where the slope of the first sustain pulse applied to the scan electrode Y is 0 or higher is 15% to 20% of one period of the sustain pulse. In this case, the period (Wc) where the slope of the second sustain pulse applied to the sustain electrode Z is 0 or higher can be set to be 80% to 85% of one period of the sustain pulse.

The Full HD is one of the standards representing resolutions and is decided according to the cell pitch of a discharge cell. The Full HD has been widely known in the same manner as XGA and thus will not be described.

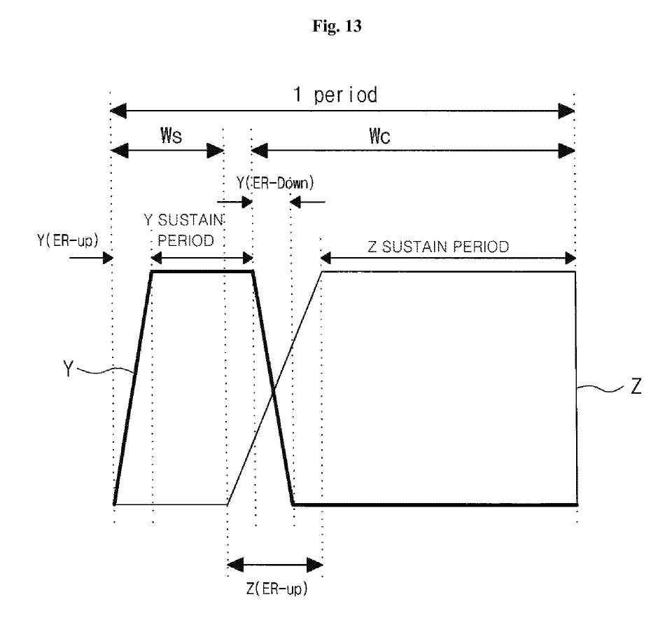

Furthermore, in the driving waveform according to the method of driving the plasma display apparatus according to an embodiment of the present invention, a falling period of a falling sustain pulse (i.e., a sustain pulse that falls (ER-Down)), i.e., an ER-Down period, and a rising period of a rising sustain pulse (i.e., a sustain pulse that rises (ER-Up)), i.e., an ER-Up period are set to be different from each other at a point where a first sustain pulse applied to the scan electrode Y and a second sustain pulse applied to the sustain electrode Z are overlapped with each other. The driving waveform in this case will be described with reference to FIG. 13.

FIG. 13 is a view illustrating, in more detail, a portion where the sustain pulses of the scan electrode and the sustain electrode.

As shown in FIG. 13, in the driving waveform according to an embodiment of the present invention, a falling period of a falling sustain pulse (i.e., a sustain pulse that falls (ER-Down)), i.e., an ER-Down period, and a rising period of a rising sustain pulse (i.e., a sustain pulse that rises (ER-Up)), i.e., an ER-Up period, at a point where a first sustain pulse applied to the scan electrode Y and a second sustain pulse applied to the sustain electrode Z are overlapped with each other, are set to be different from each other.

In this case, the ER-Down period of the sustain pulse that falls (ER-Down) can be set to be smaller than the ER-Up period of the sustain pulse that rises (ER-Up) at the point where the first sustain pulse applied to the scan electrode Y and the second sustain pulse applied to the sustain electrode Z are overlapped with each other.

Furthermore, at the overlapped point, the ER-Down period of the sustain pulse that falls (ER-Down) can be set to 400 ns or higher, and the ER-Up period of the sustain pulse that rises (ER-Up) can be set to 400 ns or higher.

It has been described that both the ER-Down period of the sustain pulse that falls (ER-Down) and the ER-Up period of the sustain pulse that rises (ER-Up) are set to 400 ns or higher. It is, however, to be understood that such range limit is true when the ER-Down period of the sustain pulse that falls (ER-Down) is smaller than or the same as the ER-Up period of the sustain pulse that rises (ER-Up) at the overlapped point.

For example, in the case where the period (Ws) where the slope of the first sustain pulse applied to the scan electrode Y is 0 or higher is shorter than the period (Wc) where the slope of the second sustain pulse applied to the sustain electrode Z is 0 or higher within one period as in the case of FIG. 13, a period where the slope of the first sustain pulse applied to the scan electrode Y is less than 0, i.e., the falling period Y (falling (ER-Down)) of the first sustain pulse applied to the scan electrode Y is smaller than the rising period Z (rising (ER-Up)) of the second sustain pulse applied to the sustain electrode Z.

In this case, the period where the slope of the first sustain pulse applied to the scan electrode Y is less than 0, i.e., the falling period Y (falling (ER-Down)) of the first sustain pulse applied to the scan electrode Y can have a length of at least 400 ns. A length of the rising period Z (rising (ER-Up)) of the second sustain pulse applied to the sustain electrode Z can be 400 ns or higher.

The reason why a falling period of a falling (ER-Down) sustain pulse, i.e. a falling (ER-Down) period, and a rising period of a rising (ER-Up) sustain pulse, i.e., a rising (ER-Up) period, at a point where the first sustain pulse applied to the scan electrode Y and the second sustain pulse applied to the sustain electrode Z are overlapped, are set to be different from each other as described above is to secure sufficient sustain discharge and also to reduce generation of noise.

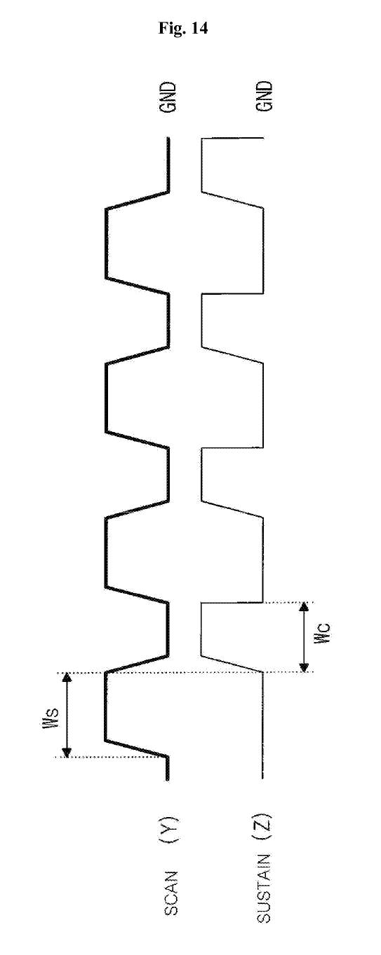

In the driving waveform described above according to an embodiment of the present invention, a case where the period (Ws) where the slope of the first sustain pulse applied to the scan electrode Y is 0 or higher (0≧) is set to be shorter than the period (Wc) where the slope of a pulse applied to the sustain electrode Z is 0 or higher (0≧) has been described above. Unlike the above example, however, the period (Ws) where the slope of the first sustain pulse applied to the scan electrode Y is 0 or higher (0≧) can be set to be longer than the period (Wc) where the slope of the second sustain pulse applied to the sustain electrode Z is 0 or higher (0≧). The driving waveform in this case will now be described with reference to FIG. 14.

FIG. 14 shows another driving waveform depending on the method of driving the plasma display apparatus according to an embodiment of the present invention.

As shown in FIG. 14, in the driving waveform depending on the method of driving the plasma display apparatus according to an embodiment of the present invention, the period (Ws) where the slope of the first sustain pulse applied to the scan electrode Y is 0 or higher (0≧) is set to be longer than the period (Wc) where the slope of the second sustain pulse applied to the sustain electrode Z is 0 or higher (0≧). Furthermore, the driving waveform of FIG. 14 is substantially the same as that of FIG. 9. Therefore, description thereof will be omitted in order to avoid redundancy.

In the driving waveform of FIG. 14, a first sustain pulse applied to the scan electrode Y is set to have a predetermined slope when rising or falling in the same manner as FIG. 11. Furthermore, a second sustain pulse applied to the sustain electrode Z also rises with it having a predetermined slope when rising or falling. Therefore, an instant potential can be reduced during a sustain discharge, and an interaction with the address electrode can be minimized accordingly.

Therefore, a phenomenon in which a discharge is attracted toward the address electrode during the sustain discharge can be reduced. It is thus possible to stably sustain discharge efficiency of each phosphor and also to reduce generation of an afterimage, i.e., a bright afterimage.

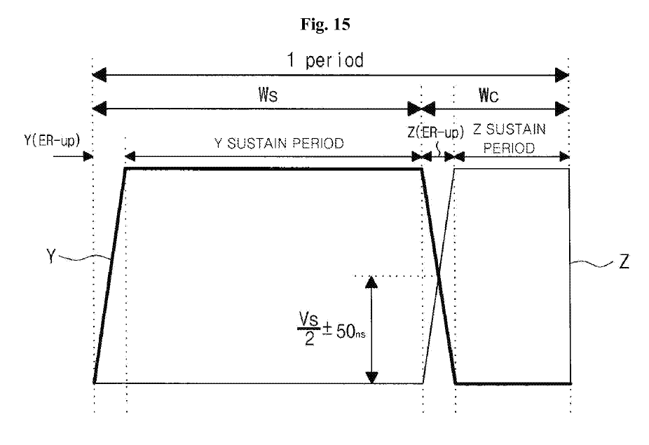

Furthermore, in the driving waveform of FIG. 14, in a similar way as FIG. 11, a first sustain pulse applied to the scan electrode Y and a second sustain pulse applied to the sustain electrode Z are overlapped with each other, and a sustain period where the sustain pulses are maintained at the sustain voltage (Vs) are different from each other. The sustain pulse in this case will be described in more detail with reference to FIG. 15.

FIG. 15 is a view illustrating, in more detail, a driving waveform according to the method of driving the plasma display apparatus according to an embodiment of the present invention.

As shown in FIG. 15, a first sustain pulse applied to the scan electrode Y and a second sustain pulse applied to the sustain electrode Z are overlapped with each other at a point where the slope of the second sustain pulse applied to the sustain electrode Z in the sustain period exceeds 0, i.e., the second sustain pulse applied to the sustain electrode Z rises (Z (rising (ER-Up)) while the slope of the first sustain pulse applied to the scan electrode Y in the sustain period is less than 0, i.e., the first sustain pulse applied to the scan electrode Y falls (Y (falling (ER-Down)).

Furthermore, in the driving waveform of FIG. 14, the period (Ws) where the slope of the first sustain pulse applied to the scan electrode Y is 0 or higher (0≧) is longer than the period (Wc) where the slope of the second sustain pulse applied to the sustain electrode Z is 0 or higher (0≧), as described above.

That is, a period where the first sustain pulse applied to the scan electrode Y is maintained at the sustain voltage (Vs) from the start when the sustain pulse rises is longer than a period where the second sustain pulse applied to the sustain electrode Z is maintained at the sustain voltage (Vs) from the start when the sustain pulse rises.

Therefore, during one period of the sustain pulse, a weak discharge and a strong discharge are alternately generated. As a result, in the same manner as the driving waveform of FIG. 9, since a weak discharge and a strong discharge are alternately generated, a phenomenon in which a discharge is attracted toward the address electrode upon discharge can be reduced. It is thus possible to improve an afterimage.

In the driving waveform of FIG. 14, a difference between the period (Ws) where the slope of the first sustain pulse applied to the scan electrode Y is 0 or higher (0≧) is longer than the period (Wc) where the slope of the second sustain pulse applied to the sustain electrode Z is 0 or higher (0≧) can be decided depending on the size of a discharge cell, i.e., a cell pitch, as in the case of FIG. 11.

That is, a period where the slope of the first sustain pulse applied to the scan electrode Y is 0 or higher (0≧) and a period where the slope of a pulse applied to the sustain electrode Z is 0 or higher (0≧) can be varied depending on the cell pitch of a discharge cell.

For example, in the case where the cell pitch of a discharge cell is VGA grade, if the period (Ws) where the slope of the first sustain pulse applied to the scan electrode Y is 0 or higher (0≧) is set to be longer than the period (Wc) where the slope of a pulse applied to the sustain electrode Z is 0 or higher (0≧), the period (Ws) where the slope of the first sustain pulse applied to the scan electrode Y is 0 or higher has a length, which is 75% to 80% of one period of the sustain pulse.

In this case, the period (Wc) where the slope of the second sustain pulse applied to the sustain electrode Z is 0 or higher can be set to be 20% to 25% of one period of the sustain pulse.

Furthermore, in the event that the cell pitch of a discharge cell is XGA grade, if the period (Ws) where the slope of the first sustain pulse applied to the scan electrode Y is 0 or higher (0≧) is set to be longer than the period (Wc) where the slope of a pulse applied to the sustain electrode Z is 0 or higher (0≧), the period (Ws) where the slope of the first sustain pulse applied to the scan electrode Y is 0 or higher is 80% to 85% of one period of the sustain pulse.

In this case, the period (Wc) where the slope of the second sustain pulse applied to the sustain electrode Z is 0 or higher can be set to be 15% to 20% of one period of the sustain pulse.

Furthermore, in the case where the cell pitch of a discharge cell is Full HD grade, if the period (Ws) where the slope of the first sustain pulse applied to the scan electrode Y is 0 or higher (0≧) is set to be longer than the period (Wc) where the slope of a pulse applied to the sustain electrode Z is 0 or higher (0≧), the period (Ws) where the slope of the first sustain pulse applied to the scan electrode Y is 0 or higher is 80% to 85% of one period of the sustain pulse.

In this case, the period (Wc) where the slope of the second sustain pulse applied to the sustain electrode Z is 0 or higher can be set to be 15% to 20% of one period of the sustain pulse.

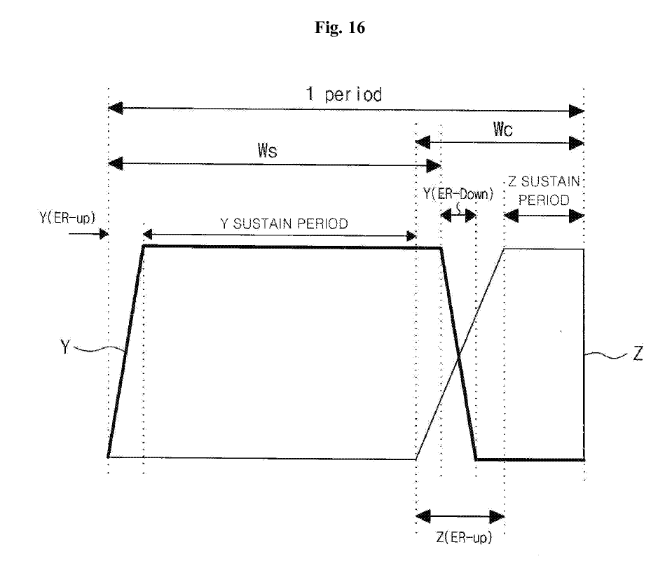

Furthermore, in the driving waveform depending on the method of driving the plasma display apparatus according to an embodiment of the present invention, as in the case of FIG. 11, a falling (ER-Down) period of a falling sustain pulse and a rising (ER-Up) period of a rising sustain pulse can be set to be different from each other at a point where the first sustain pulse applied to the scan electrode Y and the second sustain pulse applied to the sustain electrode Z are overlapped with each other. The driving waveform in this case will be described with reference to FIG. 16.

FIG. 16 is a view illustrating, in more detail, a portion where sustain pulses of a scan electrode and a sustain electrode are overlapped with each other.

As shown in FIG. 16, in the driving waveform according to an embodiment of the present invention, an ER-Down period of a sustain pulse and an ER-Up period of a sustain pulse are set to be different from each other at a point where a first sustain pulse applied to the scan electrode Y and a second sustain pulse applied to the sustain electrode Z are overlapped with each other within one period.

In this case, the ER-Down period of the sustain pulse can be set to be smaller than or the same as the ER-Up period of the sustain pulse are set to be different from each other at a point where the first sustain pulse applied to the scan electrode Y and the second sustain pulse applied to the sustain electrode Z are overlapped with each other. The driving waveform of FIG. 16 is basically the same as that of FIG. 13. Therefore, description thereof will be omitted in order to avoid redundancy.

Therefore, the present invention is advantageous in that it can enhance driving efficiency and improve a bright afterimage since a first sustain pulse applied to the scan electrode and a second sustain pulse applied to the sustain electrode are improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
a driver for driving the scan electrode and the sustain electrode; and
a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

2. The plasma display apparatus as claimed in claim 1, wherein a point where the first sustain pulse and the second sustain pulse are overlapped with each other is a point within a range of ±50 ns from a point of ½ (Vs/2) of the sustain voltage (Vs).

3. The plasma display apparatus as claimed in claim 1, wherein at the overlapped point, a falling (ER-Down) period of the sustain pulse and a rising (ER-Up) period of the sustain pulse are different from each other.

4. The plasma display apparatus as claimed in claim 3, wherein at the overlapped point, the falling (ER-Down) period of the sustain pulse is less than or equal to the rising (ER-Up) period of the sustain pulse.

5. The plasma display apparatus as claimed in claim 4, wherein at the overlapped point, the falling (ER-Down) period and the rising (ER-Up) period of the sustain pulse is 400 ns or more.

6. The plasma display apparatus as claimed in claim 5, wherein the overlapped point is a point where the first sustain pulse applied to the scan electrode falls (ER-Down) and the second sustain pulse applied to the sustain electrode rises (ER-Up).

7. A plasma display apparatus comprising:
a plasma display panel comprising a scan electrode and a sustain electrode;
a driver for driving the scan electrode and the sustain electrode; and
a sustain pulse controller for controlling the driver so that a first sustain pulse applied to the scan electrode and a second sustain pulse applied to the sustain electrode are overlapped with each other, and for setting a rising (ER-Up) period of the first sustain pulse applied to the scan electrode and a Y sustain period where the first sustain pulse is maintained at a sustain voltage (Vs), and a rising (ER-Up) period of the second sustain pulse applied to the sustain electrode and a Z sustain period where the second sustain pulse is maintained at the sustain voltage (Vs) are varied depending on a cell pitch of a discharge cell.

8. The plasma display apparatus as claimed in claim 7, wherein as the cell pitch of the discharge cell decreases, a difference between the rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) increases.

9. The plasma display apparatus as claimed in claim 8, wherein the cell pitch of the discharge cell is a Full High Definition (Full HD) grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

10. The plasma display apparatus as claimed in claim 8, wherein where the cell pitch of the discharge cell is an Extended Graphics Array (XGA) grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

11. A method of driving a plasma display panel comprising a scan electrode and a sustain electrode,
overlapping a first sustain pulse applied to the scan electrode and a second sustain pulse applied to the sustain electrode with each other; and
setting a rising (ER-Up) period of the first sustain pulse applied to the scan electrode and a Y sustain period where the first sustain pulse is maintained at a sustain voltage (Vs) to be different from a rising (ER-Up) period of the second sustain pulse applied to the sustain electrode and a Z sustain period where the second sustain pulse is maintained at the sustain voltage (Vs).

12. The method as claimed in claim 11, wherein a point where the first sustain pulse applied to the scan electrode and the second sustain pulse applied to the sustain electrode are overlapped with each other is a point within a range of ±50 ns from a point of ½ (Vs/2) of the sustain voltage (Vs).

13. The method as claimed in claim 11, wherein at the overlapped point, a falling (ER-Down) period of the sustain pulse and a rising (ER-Up) period of the sustain pulse are different from each other.

14. The method as claimed in claim 13, wherein at the overlapped point, the falling (ER-Down) period of the sustain pulse is less than or equal to the rising (ER-Up) period of the sustain pulse.

15. The method as claimed in claim 14, wherein at the overlapped point, the falling (ER-Down) period and the rising (ER-Up) period of the sustain pulse is 400 ns or more.

16. The method as claimed in claim 15, wherein the overlapped point is a point where the first sustain pulse applied to the scan electrode falls (ER-Down) and the second sustain pulse applied to the sustain electrode rises (ER-Up).

17. The method as claimed in claim 11, wherein the rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) are varied depending on a cell pitch of a discharge cell.

18. The method as claimed in claim 17, wherein as the cell pitch of the discharge cell decreases, a difference between the rising (ER-Up) period of the first sustain pulse applied to the scan electrode and the Y sustain period where the first sustain pulse is maintained at the sustain voltage (Vs), and the rising (ER-Up) period of the second sustain pulse applied to the sustain electrode and the Z sustain period where the second sustain pulse is maintained at the sustain voltage (Vs) increases.

19. The method as claimed in claim 18, wherein in the case where the cell pitch of the discharge cell is a Full HD grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.

20. The method as claimed in claim 18, wherein in the case where the cell pitch of the discharge cell is an XGA grade, the rising (ER-Up) period of the sustain pulse applied to any one of the scan electrode and the sustain electrode, and the sustain period where the sustain pulse is maintained at the sustain voltage (Vs) has a length of 15% to 20% of one period of the sustain pulse.
